(19) United States
(12) Patent Application Publication
(10) Pub. No.: US 2024/0204217 A1
(43) Pub. Date: Jun. 20, 2024

(54) FUEL CELL STACK

(71) Applicant: HONDA MOTOR CO., LTD., Tokyo (JP)

(72) Inventors: Suguru OMORI, Wako-shi (JP); Yuta SUGIHARA, Wako-shi (JP); Satoshi OYAMA, Wako-shi (JP)

(21) Appl. No.: 18/534,052

(22) Filed: Dec. 8, 2023

(30) Foreign Application Priority Data
Dec. 16, 2022 (JP) 2022-200764

(51) Int. Cl. H01M 8/0276; H01M 8/0247; H01M 8/248

(52) U.S. Cl. CPC H01M 8/0276; H01M 8/0247; H01M 8/248

(57) ABSTRACT

Bead seals of separators are compressed by applying a fastening load in a stacking direction to a stack body that includes a plurality of unit cells in a fuel cell stack. A height of the bead seals in the stacking direction after compression is lower than a height of the bead seals in the stacking direction before the compression, and a height of the feed ridge in the stacking direction is lower than the height of the bead seals in the stacking direction after the compression.

### CROSS-REFERENCE TO RELATED APPLICATIONS

This application is based upon and claims the benefit of priority from Japanese Patent Application No. 2022-200764 filed on Dec. 16, 2022, the contents of which are incorporated herein by reference.

### BACKGROUND OF THE INVENTION

### Field of the Invention

The present invention relates to a fuel cell stack in which unit cells are stacked.

### Description of the Related Art

The fuel cell stack includes a plurality of stacked unit cells. Each of the unit cells includes a membrane electrode assembly (MEA) and a pair of separators (a first separator and a second separator) sandwiching the MEA. The MEA includes a solid polymer electrolyte membrane, an anode, and a cathode. The solid polymer electrolyte membrane is formed of a polymer ion exchange membrane. The anode is disposed on one surface of the solid polymer electrolyte membrane. The cathode electrode is disposed on another surface of the solid polymer electrolyte membrane.

A plurality of ridges are formed on both surfaces of each separator. Thus, a flow field (fuel gas flow field) for allowing the fuel gas to flow and a bead seal for sealing the flow field are formed between the MEA and the first separator. Further, a flow field (oxygen-containing gas flow field) for allowing the oxygen-containing gas to flow and a bead seal for sealing the flow field are formed between the MEA and the second separator. In addition, in two unit cells adjacent to each other, a flow field (coolant flow field) for allowing a coolant to flow is formed between a first separator of one unit cell and a second separator of the other unit cell.

JP 2020-136176 A discloses a separator for applying a uniform compression load to a bead seal. The separator disclosed in JP 2020-136176 A has a ridge between a bead seal surrounding the fluid passage and a bead seal formed on a marginal portion of the separator. The height of the ridge is lower than the height of the bead seal. With this structure, when the bead seal is compressed, the ridge absorbs the displacement of the bead seal.

### SUMMARY OF THE INVENTION

For example, when an impact load in the stacking direction is applied to a stack body of a plurality of unit cells due to a collision or the like of a fuel cell vehicle, the bead seal is compressed and deformed. If the bead seal is deformed greatly, there is a possibility that gas leaks from the flow field enclosed by the bead seal.

An object of the present invention is to solve the aforementioned problem.

A fuel cell stack according to an aspect of the present invention includes unit cells stacked in a stacking direction, the unit cells each including a membrane electrode assembly and a pair of separators which sandwich the membrane electrode assembly, wherein each of the pair of separators includes a reactant gas flow field including a flow field ridge protruding toward the membrane electrode assembly to allow a reactant gas to flow along an electrode surface of the membrane electrode assembly, a plurality of fluid passages penetrating the separator in a thickness direction of the separator and allowing the reactant gas to flow through the fluid passages, a plurality of feed regions each including a feed ridge protruding toward the membrane electrode assembly and each configured to allow communication between the reactant gas flow field and the fluid passages, a bead seal protruding toward the membrane electrode assembly and configured to seal a space between the membrane electrode assembly and the reactant gas flow field, and between the membrane electrode assembly and the feed regions, and wherein a fastening load in the stacking direction is applied to a stack body including the plurality of the unit cells, whereby the bead seals of the respective separators are compressed, a height of the bead seals in the stacking direction after compression is lower than a height of the bead seals in the stacking direction before the compression, a height of the feed ridge in the stacking direction is lower than the height of the bead seals in the stacking direction after the compression.

According to the present invention, deformation of the bead seal can be suppressed.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an explanatory perspective view of a fuel cell stack;

FIG. 2 is an exploded perspective view of the fuel cell stack;

FIG. 3 is a cross-sectional view taken along line III-III of FIG. 2;

FIG. 4 is an explanatory exploded perspective view showing a unit cell of the fuel cell stack;

FIG. 5 is a plan view of a first separator as viewed from the MEA;

FIG. 6 is a plan view of a second separator as viewed from the MEA;

FIG. 7 is a plan view of the first separator as viewed from the second separator facing the first separator;

FIG. 8 is a plan view of the second separator as viewed from the first separator facing the second separator;

FIG. 9A is a schematic cross-sectional view of an outer bead seal perpendicular to the separator; and

FIG. 9B is a schematic cross-sectional view of each of the outer bead seal, a feed ridge, and a flow field ridge perpendicular to the separator.

### DETAILED DESCRIPTION OF THE INVENTION

### 1 Configuration of Fuel Cell Stack 10

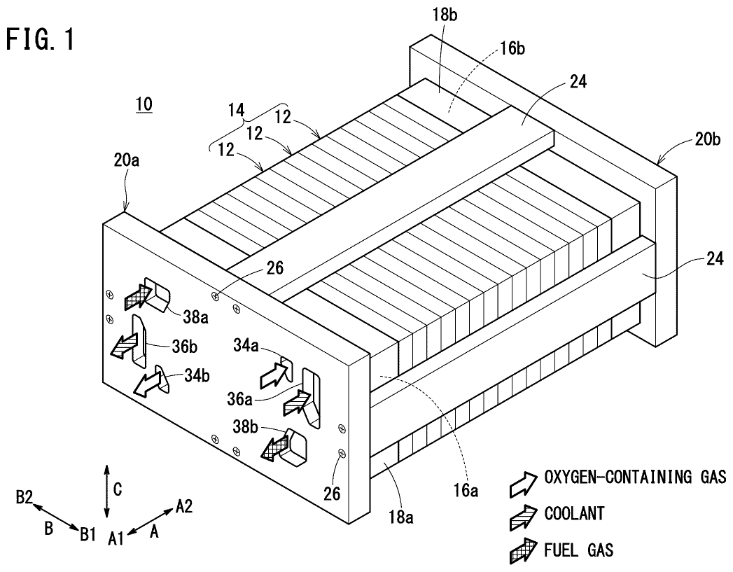

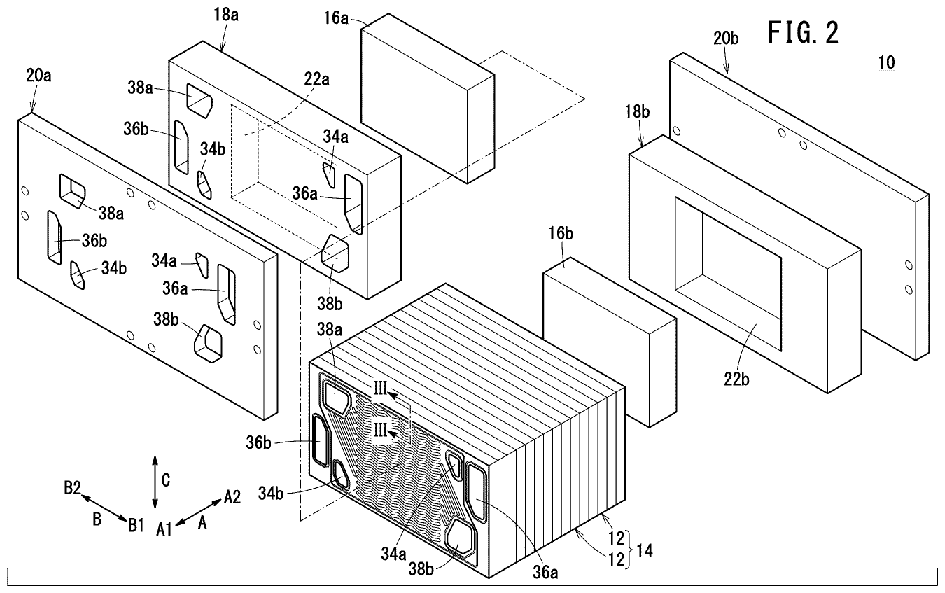

As shown in FIGS. 1 and 2, a fuel cell stack 10 includes a stack body 14 in which a plurality of unit cells 12 are stacked in a first direction (the direction of arrow A). The fuel cell stack 10 is used as, for example, power generation equipment of a fuel cell vehicle or each facility.

### [1-1 Configuration of Periphery of Stack Body 14]

At a first end portion of the fuel cell stack 10 in the direction of arrow A1, a terminal plate 16a, an insulator 18a, and an end plate 20a are arranged in this order toward the outside (in the direction of arrow A1) (see FIG. 2). At a second end portion of the fuel cell stack 10 in the direction of arrow A2, a terminal plate 16b, an insulator 18b, and an end plate 20b are arranged in this order toward the outside (in the direction of arrow A2).

The terminal plates 16a and 16b are made of a conductive material. The insulators 18a and 18b are made of an insulating material. As shown in FIG. 2, a concave portion 22a that opens toward the stack body 14 is formed in the central portion of the insulator 18a. Similarly, a concave portion 22b that opens toward the stack body 14 is formed in the central portion of the insulator 18b. The terminal plate 16a is accommodated in the concave portion 22a. The terminal plate 16b is accommodated in the concave portion 22b. The stack body 14 is positioned between the insulator 18a and the insulator 18b.

As shown in FIG. 1, each of the end plates 20a, 20b are formed in a rectangular shape having long sides extending in the second direction (the direction of arrow B) and short sides extending in the third direction (the direction of arrow C). The first direction, the second direction, and the third direction are perpendicular to each other. Coupling bars 24 are disposed between the respective sides of the end plates 20a and 20b. One end of each of the coupling bars 24 is fixed to an inner surface of the end plate 20a using bolts 26. Another end of each of the coupling bars 24 is fixed to an inner surface of the end plate 20b using bolts 26. Thus, a fastening load in the stacking direction (the direction of arrow A) is applied to the stack body 14.

At first end portions of the insulator 18a and the end plate 20a in the direction of arrow B1, an oxygen-containing gas supply passage 34a, a coolant supply passage 36a, and a fuel gas discharge passage 38b are provided. At second end portions of the insulator 18a and the end plate 20a in the direction of arrow B2, a fuel gas supply passage 38a, a coolant discharge passage 36b, and an oxygen-containing gas discharge passage 34b are provided.

### [1-2 Configurations of Stack Body 14 and Unit Cell 12]

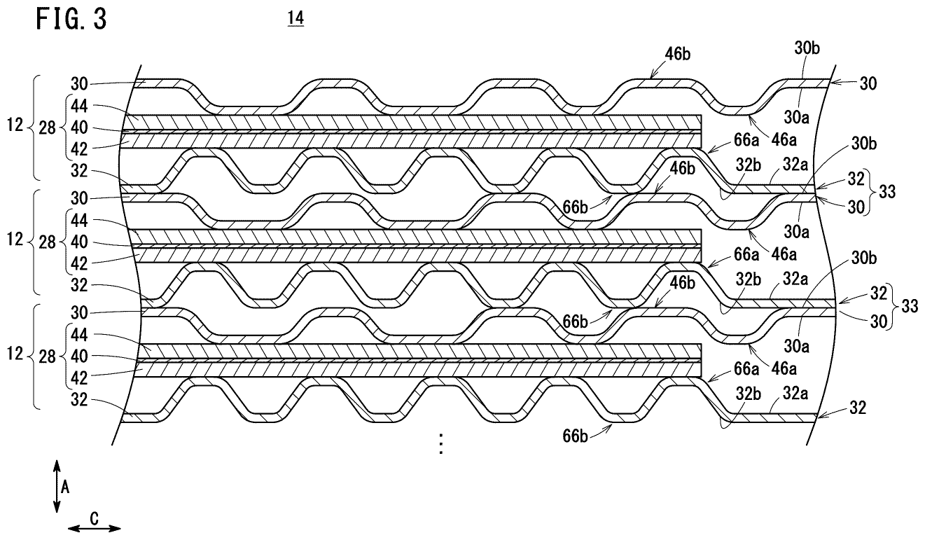

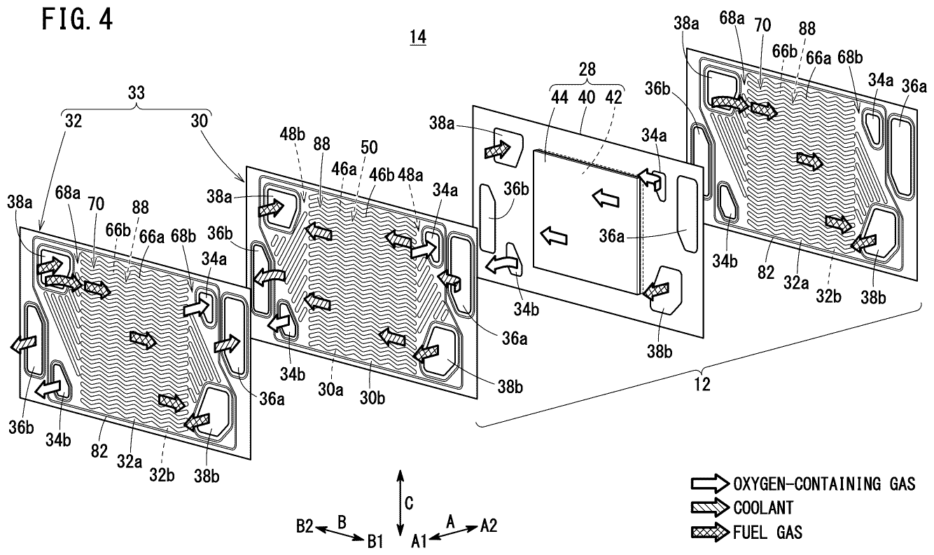

As shown in FIGS. 3 and 4, each of the unit cells 12 constituting the stack body 14 includes a membrane electrode assembly 28 (hereinafter also referred to as a “MEA 28”) and a pair of separators (first and second separators 30 and 32). The first separator 30 and the second separator 32 sandwich the MEA 28 therebetween. The first separator 30 and the second separator 32 are formed of, for example, a metal sheet such as a steel sheet, a stainless steel sheet, an aluminum sheet, or a plated steel sheet. The surface of the metal sheet may be subjected to a surface treatment for protection against corrosion.

In two unit cells 12 adjacent to each other, the first separator 30 of one unit cell 12 and the second separator 32 of another unit cell 12 are joined to each other. A joint body including the first separator 30 and the second separator 32 is referred to as a joint separator 33. That is, the stack body 14 is also a structure in which each of the MEAs 28 is sandwiched between two joint separators 33.

As shown in FIG. 2, at the first end portion of the unit cell 12 in the direction of arrow B1, the oxygen-containing gas supply passage 34a, the coolant supply passage 36a, and the fuel gas discharge passage 38b are provided. The oxygen-containing gas supply passages 34a of the respective unit cells 12 are arranged in the direction of arrow A, and communicate with each other. The oxygen-containing gas supply passage 34a of the stack body 14 communicates with the oxygen-containing gas supply passages 34a of the insulator 18a and the end plate 20a. The coolant supply passages 36a of the respective unit cells 12 are arranged in the direction of arrow A and communicate with each other. The coolant supply passage 36a of the stack body 14 communicates with the coolant supply passages 36a of the insulator 18a and the end plate 20a. The fuel gas discharge passages 38b of the respective unit cells 12 are arranged in the direction of arrow A and communicate with each other. The fuel gas discharge passage 38b of the stack body 14 communicates with the fuel gas discharge passages 38b of the insulator 18a and the end plate 20a.

As shown in FIG. 2, at the second end portion of the unit cell 12 in the direction of arrow B2, the fuel gas supply passage 38a, the coolant discharge passage 36b, and the oxygen-containing gas discharge passage 34b are provided. The fuel gas supply passages 38a of the respective unit cells 12 are arranged in the direction of arrow A and communicate with each other. The fuel gas supply passage 38a of the stack body 14 communicates with the fuel gas supply passages 38a of the insulator 18a and the end plate 20a. The coolant discharge passages 36b of the respective unit cells 12 are arranged in the direction of arrow A and communicate with each other. The coolant discharge passage 36b of the stack body 14 communicates with the coolant discharge passage 36b of the insulator 18a and the end plate 20a. The oxygen-containing gas discharge passages 34b of the respective unit cells 12 are arranged in the direction of arrow A, and communicate with each other. The oxygen-containing gas discharge passage 34b of the stack body 14 communicates with the oxygen-containing gas discharge passages 34b of the insulator 18a and the end plate 20a.

### [1-2-1 Configuration of Membrane Electrode Assembly 28 (MEA 28)]

As shown in FIG. 3, each of the MEAs 28 has an electrolyte membrane 40, an anode 42, and a cathode 44. A resin film (not shown) is provided on the outer periphery of the electrolyte membrane 40. The anode 42 and the cathode 44 sandwich the solid polymer electrolyte membrane 40.

The electrolyte membrane 40, for example, is a solid polymer electrolyte membrane (cation ion exchange membrane). The solid polymer electrolyte membrane is formed by impregnating a thin membrane of perfluorosulfonic acid with water, for example. A fluorine based electrolyte membrane may be used as the electrolyte membrane 40. Alternatively, an HC (hydrocarbon) based electrolyte membrane may be used as the electrolyte membrane 40.

The anode 42 and the cathode 44 each include a gas diffusion layer (not shown) and an electrode catalyst layer (not shown). The gas diffusion layer is formed of carbon paper or the like. The electrode catalyst layer is formed by depositing porous carbon particles uniformly on the surface of the gas diffusion layer, and platinum alloy is supported on surfaces of the carbon particles. The electrode catalyst layers are formed on both surfaces of the solid polymer electrolyte membrane 40.

### [1-2-2 Configuration of Front Surface 30a of First Separator 30]

As shown in FIG. 4, the first separator 30 covers the cathode 44 on the MEA 28. The first separator 30 has a front surface 30a facing the MEA 28 and a back surface 30b facing the second separator 32. A plurality of ridges or protrusions are formed on each of the front surface 30a and the back surface 30b by press forming. On the front surface 30a, each of the ridges protruding toward the MEA 28 is referred to as an inward ridge 46a. On the back surface 30b, each of the ridges protruding toward the second separator 32 is referred to as an outward ridge 46b.

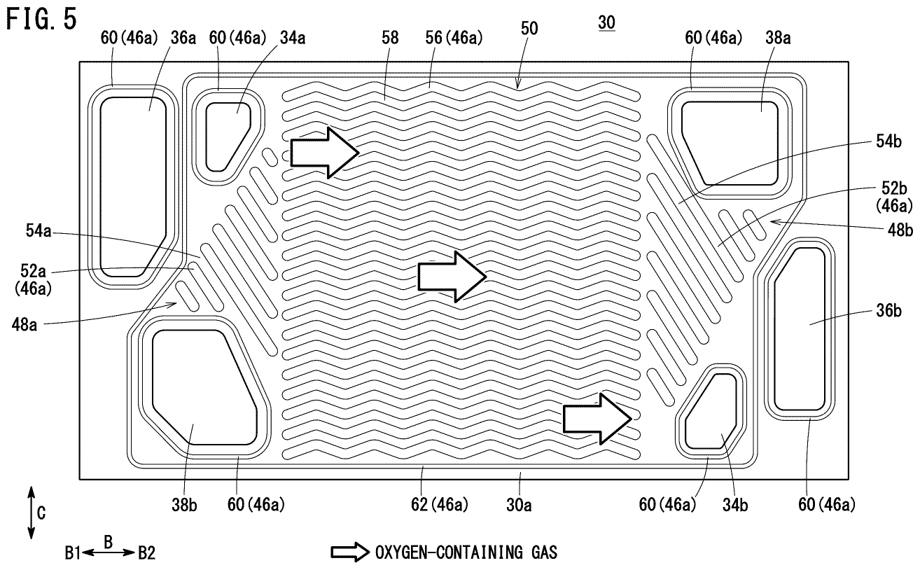

As shown in FIGS. 4 and 5, two oxygen-containing gas feed regions 48a and 48b, and an oxygen-containing gas flow field 50 are formed on the front surface 30a of the first separator 30 by the plurality of inward ridges 46a. The oxygen-containing gas feed region 48a allows the oxygen-containing gas from the oxygen-containing gas supply passage 34a to flow into the oxygen-containing gas flow field 50. The oxygen-containing gas feed region 48b allows the oxygen-containing gas from the oxygen-containing gas flow field 50 to flow into the oxygen-containing gas discharge passage 34b. The oxygen-containing gas flow field 50 is located between the oxygen-containing gas feed region 48a and the oxygen-containing gas feed region 48b, and faces the cathode 44. The two oxygen-containing gas feed regions 48a, 48b and the oxygen-containing gas flow field 50 connect and communicate with the oxygen-containing gas supply passage 34a and the oxygen-containing gas discharge passage 34b.

Among the plurality of inward ridges 46a, the inward ridges 46a forming the oxygen-containing gas feed region 48a are referred to as feed ridges 52a. Each of the feed ridges 52a extends linearly from the oxygen-containing gas supply passage 34a to the first end portion (an end portion in the direction of arrow B1) of the oxygen-containing gas flow field 50. Feed grooves 54a are located adjacent to the feed ridges 52a.

Among the plurality of inward ridges 46a, the inward ridges 46a forming the oxygen-containing gas feed region 48b are referred to as feed ridges 52b. Each of the feed ridges 52b extends linearly from the oxygen-containing gas discharge passage 34b to the second end portion (an end portion in the direction of arrow B2) of the oxygen-containing gas flow field 50. A feed groove 54b is located between the two feed ridges 52b that are adjacent to each other.

Among the plurality of inward ridges 46a, the inward ridges 46a forming the oxygen-containing gas flow field 50 are referred to as flow field ridges 56. In plan view of the first separator 30, each of the flow field ridges 56 has a wavy shape extending in the direction of arrow B. A flow field groove 58 is located between the two flow field ridges 56 that are adjacent to each other. Each of the flow field grooves 58 has a wavy shape as well. Each of the flow field ridges 56 is in contact with the cathode 44 of the MEA 28 located in the direction of arrow A2. The plurality of flow field grooves 58 serve as pathways through which the oxygen-containing gas flows.

The respective fluid passages or holes (the oxygen-containing gas supply passage 34a, the coolant supply passage 36a, the fuel gas discharge passage 38b, the fuel gas supply passage 38a, the coolant discharge passage 36b, and the oxygen-containing gas discharge passage 34b) are surrounded by the inward ridges 46a. These inward ridges 46a are referred to as passage bead seals 60. Each of the passage bead seals 60 is in contact with the MEA 28 located in the direction of arrow A2. Thus, the plurality of passage bead seals 60 seal the plurality of fluid passages.

A plurality of flow paths (not shown) communicating with the oxygen-containing gas supply passage 34a and the oxygen-containing gas feed region 48a are formed in the passage bead seal 60 surrounding the oxygen-containing gas supply passage 34a. Similarly, a plurality of flow paths (not shown) communicating with the oxygen-containing gas discharge passage 34b and the oxygen-containing gas feed region 48b are formed in the passage bead seal 60 surrounding the oxygen-containing gas discharge passage 34b.

An area including the two oxygen-containing gas feed regions 48a, 48b, the oxygen-containing gas flow field 50, the oxygen-containing gas supply passage 34a, the fuel gas discharge passage 38b, the fuel gas supply passage 38a, and the oxygen-containing gas discharge passage 34b is surrounded by the inward ridge 46a. This inward ridge 46a is referred to as an outer bead seal 62. The outer bead seal 62 is in contact with the MEA 28 located in the direction of arrow A2. Thus, the outer bead seal 62 seals an area where the oxygen-containing gas flows between the front surface 30a and the MEA 28 (an area including the two oxygen-containing gas feed regions 48a, 48b, the oxygen-containing gas flow field 50, the oxygen-containing gas supply passage 34a, and the oxygen-containing gas discharge passage 34b).

### [1-2-3 Configuration of Front Surface 32a of Second Separator 32]

As shown in FIG. 4, the second separator 32 covers the anode 42 on the MEA 28. The second separator 32 has a front surface 32a facing the MEA 28 and a back surface 32b facing the first separator 30. A plurality of ridges or protrusions are formed on each of the front surface 32a and the back surface 32b by press forming. On the front surface 32a, each of the ridges protruding toward the MEA 28 is referred to as an inward ridge 66a. On the back surface 32b, each of the ridges protruding toward the first separator 30 is referred to as an outward ridge 66b.

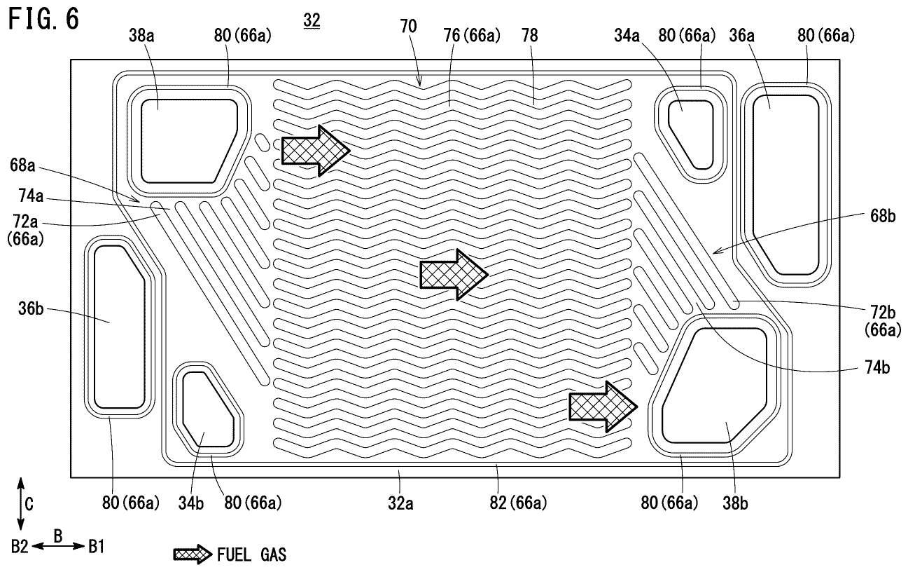

As shown in FIGS. 4 and 6, two fuel gas feed regions 68a and 68b, and a fuel gas flow field 70 are formed on the front surface 32a of the second separator 32 by the plurality of inward ridges 66a. The fuel gas feed region 68a allows the fuel gas from the fuel gas supply passage 38a to flow into the fuel gas flow field 70. The fuel gas feed region 68b allows the fuel gas from the fuel gas flow field 70 to flow into the fuel gas discharge passage 38b. The fuel gas flow field 70 is located between the fuel gas feed region 68a and the fuel gas feed region 68b, and faces the anode 42. The two fuel gas feed regions 68a, 68b and the fuel gas flow field 70 connect and communicate with the fuel gas supply passage 38a and the fuel gas discharge passage 38b.

Among the plurality of inward ridges 66a, the inward ridges 66a forming the fuel gas feed region 68a are referred to as feed ridges 72a. Each of the feed ridges 72a extends linearly from the fuel gas supply passage 38a to the first end portion (an end portion in the direction of arrow B2) of the fuel gas flow field 70. A feed groove 74a is located between the two feed ridges 72a that are adjacent to each other.

Among the plurality of inward ridges 66a, the inward ridges 66a forming the fuel gas feed region 68b are referred to as feed ridges 72b. Each of the feed ridges 72b extends linearly from the fuel gas discharge passage 38b to the second end portion (an end portion in the direction of arrow B1) of the fuel gas flow field 70. A feed groove 74b is located between the two feed ridges 72b that are adjacent to each other.

Among the plurality of inward ridges 66a, the inward ridges 66a forming the fuel gas flow field 70 are referred to as flow field ridges 76. In plan view of the second separator 32, each of the flow field ridges 76 has a wavy shape extending in the direction of arrow B. A flow field groove 78 is located between the two flow field ridges 76 that are adjacent to each other. Each of the flow field grooves 78 has a wavy shape as well. Each of the flow field ridges 76 is in contact with the anode 42 of the MEA 28 located in the direction of arrow A1. The plurality of flow field grooves 78 serve as pathways through which the fuel gas flows.

The waveform of the flow field ridges 76 and the flow field grooves 78 in the front surface 32a of the second separator 32 differs from the waveform of the flow field ridges 56 and the flow field grooves 58 in the front surface 30a of the first separator 30, in at least one of phase, period, or amplitude.

The respective fluid passages or holes (the fuel gas supply passage 38a, the coolant discharge passage 36b, the oxygen-containing gas discharge passage 34b, the oxygen-containing gas supply passage 34a, the coolant supply passage 36a, and the fuel gas discharge passage 38b) are surrounded by the inward ridges 66a. These inward ridges 66a are referred to as passage bead seals 80. Each of the passage bead seals 80 is in contact with the MEA 28 located in the direction of arrow A1. Thus, the plurality of passage bead seals 80 seal the plurality of fluid passages.

A plurality of flow paths (not shown) communicating with the fuel gas supply passage 38a and the fuel gas feed region 68a are formed in the passage bead seal 80 surrounding the fuel gas supply passage 38a. Similarly, a plurality of flow paths (not shown) communicating with the fuel gas discharge passage 38b and the fuel gas feed region 68b are formed in the passage bead seal 80 surrounding the fuel gas discharge passage 38b.

An area including the two fuel gas feed regions 68a and 68b, the fuel gas flow field 70, the fuel gas supply passage 38a, the oxygen-containing gas discharge passage 34b, the oxygen-containing gas supply passage 34a, and the fuel gas discharge passage 38b is surrounded by the inward ridge 66a. This inward ridge 66a is referred to as an outer bead seal 82. The outer bead seal 82 is in contact with the MEA 28 located in the direction of arrow A1. Thus, the outer bead seal 82 seals an area where the fuel gas flows between the front surface 32a and the MEA 28 (an area including the two fuel gas feed regions 68a, 68b, the fuel gas flow field 70, the fuel gas supply passage 38a, and the fuel gas discharge passage 38b).

[1-2-4 Configuration of Back Surface 30b and Back Surface 32b]

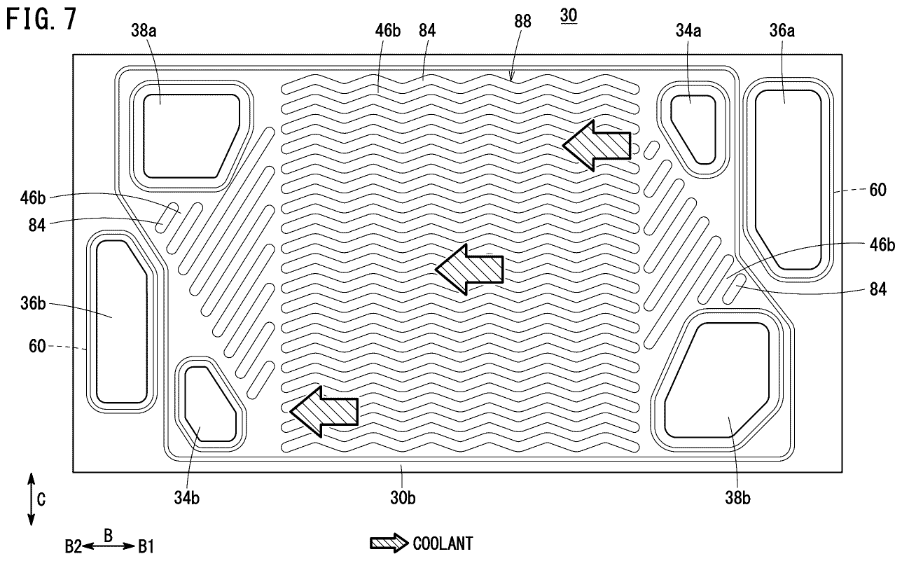

As shown in FIG. 7, in the back surface 30b of the first separator 30, the outward ridges 46b are located on the back side of the grooves (the feed grooves 54a and 54b, the flow field grooves 58, etc.) of the front surface 30a. Outward grooves 84 are located adjacent to the outward ridges 46b. The outward grooves 84 are located on the back side of the inward ridges 46a (the feed ridges 52a and 52b, the flow field ridges 56, etc.) of the front surface 30a.

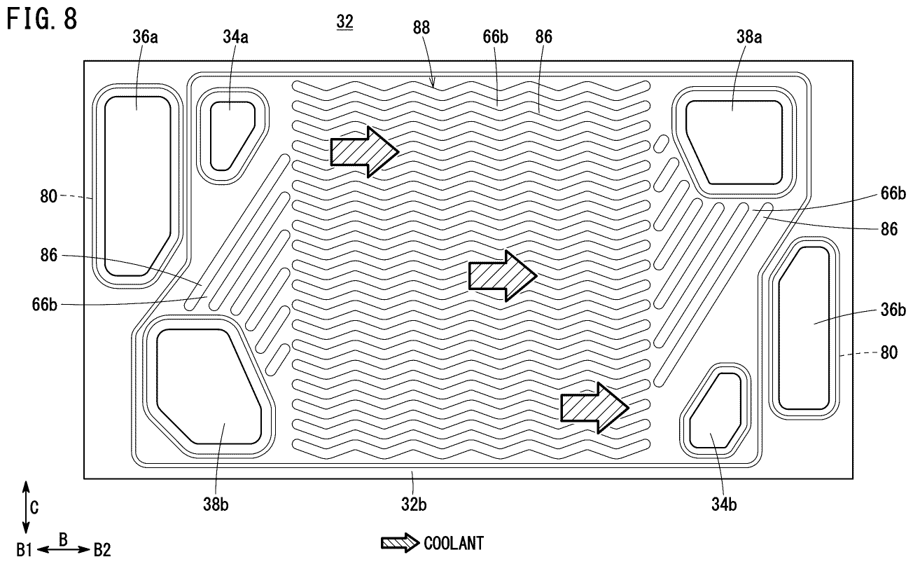

As shown in FIG. 8, in the back surface 32b of the second separator 32, the outward ridges 66b are located on the back side of the grooves (the feed grooves 74a and 74b, the flow field grooves 78, etc.) of the front surface 32a. Outward grooves 86 are located adjacent to the outward ridges 66b. The outward grooves 86 are located on the back side of the inward ridges 66a (the feed ridges 72a and 72b, the flow field ridges 76, etc.) of the front surface 32a.

The waveform of the outward ridges 46b located on the back side of flow field grooves 58 in the first separator 30 differs from the waveform of the outward ridges 66b located on the back side of flow field grooves 78 in the second separator 32, in at least one of phase, period, or amplitude.

As shown in FIG. 4, the back surface 30b of the first separator 30 and the back surface 32b of the second separator 32 face each other, and some of the outward ridges 46b and some of the outward ridges 66b are welded to each other. Further, the marginal portion of the first separator 30 and the marginal portion of the second separator 32 are welded. Also, parts of the first separator 30 and the second separator 32 located around each of the fluid passages are welded to each other. A coolant flow field 88 is formed between the back surface 30b of the first separator 30 and the back surface 32b of the second separator 32.

Some of the outward ridges 46b of the first separator 30 are in contact with some of the outward ridges 66b of the second separator 32. Some of the outward grooves 84 of the first separator 30 overlap some of the outward grooves 86 of the second separator 32.

A plurality of flow paths (not shown) communicating with the coolant supply passage 36a and the outward grooves 84 are formed in the passage bead seal 60 surrounding the coolant supply passage 36a of the first separator 30. Similarly, a plurality of flow paths (not shown) communicating with the coolant supply passage 36a and the outward grooves 86 are formed in the passage bead seal 80 surrounding the coolant supply passage 36a of the second separator 32.

A plurality of flow paths (not shown) communicating with the coolant discharge passage 36b and the outward grooves 84 are formed in the passage bead seal 60 surrounding the coolant discharge passage 36b of the first separator 30. Similarly, a plurality of flow paths (not shown) communicating with the coolant discharge passage 36b and the outward grooves 86 are formed in the passage bead seal 80 surrounding the coolant discharge passage 36b of the second separator 32.

### 2 Operation of Fuel Cell Stack 10

As shown in FIG. 1, an oxygen-containing gas is supplied to the oxygen-containing gas supply passage 34a of the end plate 20a. A fuel gas such as a hydrogen containing gas or the like is supplied to the fuel gas supply passage 38a of the end plate 20a. A coolant (such as pure water) is supplied to the coolant supply passage 36a in the end plate 20a. In each of the unit cells 12, each fluid flows as follows.

As shown in FIG. 4, the oxygen-containing gas supplied to the oxygen-containing gas supply passage 34a flows into the oxygen-containing gas feed region 48a. The oxygen-containing gas flowing into the oxygen-containing gas feed region 48a is uniformly distributed to the plurality of flow field grooves 58 of the oxygen-containing gas flow field 50. In the oxygen-containing gas flow field 50, the oxygen-containing gas is supplied to the cathode 44 of the MEA 28. On the other hand, the fuel gas supplied to the fuel gas supply passage 38a flows into the fuel gas feed region 68a. The fuel gas flowing into the fuel gas feed region 68a is uniformly distributed to the plurality of flow field grooves 78 of the fuel gas flow field 70. The fuel gas is supplied to the anode 42 of the MEA 28 in the fuel gas flow field 70. In each of the MEAs 28, the oxygen-containing gas supplied to the cathode 44 and the fuel gas supplied to the anode 42 induce chemical reactions, and thereby generate electricity. Water is generated as a result of the chemical reactions.

Then, the unreacted oxygen-containing gas and water flow into the oxygen-containing gas feed region 48b from the oxygen-containing gas flow field 50. Further, the oxygen-containing gas flowing into the oxygen-containing gas feed region 48b flows out to the oxygen-containing gas discharge passage 34b. On the other hand, the unreacted fuel gas flows into the fuel gas feed region 68b from the fuel gas flow field 70. Further, the fuel gas flowing into the fuel gas feed region 68b flows out to the fuel gas discharge passage 38b.

The coolant supplied to the coolant supply passage 36a flows into the coolant flow field 88. In the coolant flow field 88, the coolant cools the MEA 28 located in the direction of arrow A. The coolant in the coolant flow field 88 flows out to the coolant discharge passage 36b.

### 3 Heights of Inward Ridges 46a and 66a

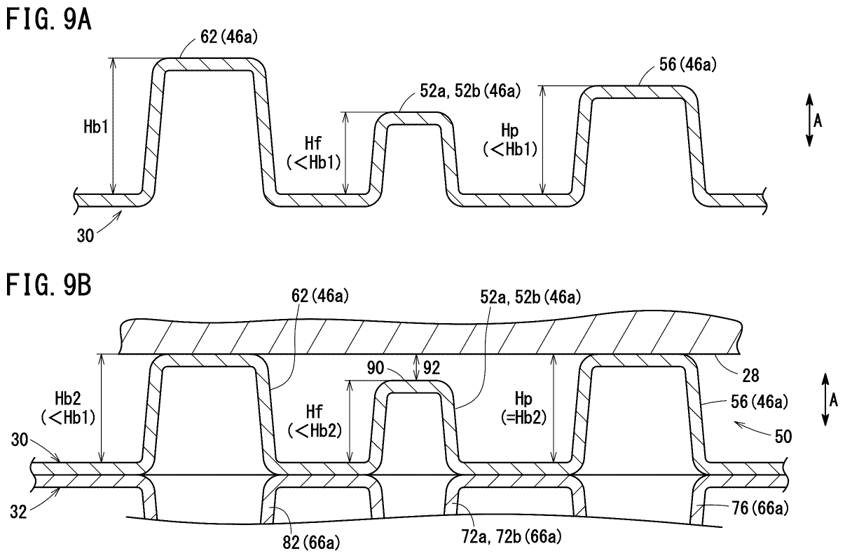

Referring to FIGS. 9A and 9B, the heights of the inward ridges 46a and 66a of the first separator 30 and the second separator 32 in the stacking direction (the direction of arrow A) will be described. The bead seals (the passage bead seals 60 and 80 and the outer bead seals 62 and 82) of the inward ridges 46a and 66a have the same height. Here, the height of the outer bead seal 62 of the first separator 30 will be described, and the height of the passage bead seal 60 of the first separator 30, the height of the passage bead seal 80 of the second separator 32, and the height of the outer bead seal 82 of the second separator 32 will not be described.

As shown in FIG. 1, the plurality of coupling bars 24 are fixed to the two end plates 20a and 20b by the bolts 26, whereby a fastening load in the stacking direction (the direction of arrow A) is applied to the stack body 14. As shown in FIG. 9A, the outer bead seal 62 of the first separator 30 has a height Hb1 before a fastening load in the stacking direction is applied to the stack body 14. When a fastening load in the stacking direction is applied to the stack body 14, the outer bead seal 62 of the first separator 30 is compressed in the stacking direction by the MEA 28 and the second separator 32. As shown in FIG. 9B, the compressed outer bead seal 62 has a height Hb2. The height Hb2 after compression is lower than the height Hb1 before compression.

On the other hand, the flow field ridge 56 of the first separator 30 has a height Hp. The height Hp of the flow field ridge 56 does not change before and after the fastening load in the stacking direction is applied to the stack body 14. The height Hp of the flow field ridge 56 is equal to the height Hb2 of the compressed outer bead seal 62.

The feed ridges 52a and 52b of the first separator 30 have a height Hf. The height Hf of the feed ridges 52a and 52b does not change before and after the fastening load in the stacking direction is applied to the stack body 14. The height Hf of the feed ridges 52a and 52b is lower than the height Hb2 of the compressed outer bead seal 62. In other words, the height Hb2 of the compressed outer bead seal 62 is higher than the height Hf of the feed ridges 52a, 52b. Therefore, a gap 92 is formed between top portions 90 of the feed ridges 52a and 52b and the MEA 28. That is, the top portions 90 of the feed ridges 52a and 52b do not contact the MEA 28 in a state in which a fastening load is applied to the stack body 14.

For example, when an impact load in the direction of arrow A is applied to the fuel cell stack 10 due to a collision or the like of a fuel cell vehicle, the stack body 14 is pressed in the stacking direction (direction of arrow A). Further, when the impact load becomes equal to or greater than the load capacity of the outer bead seal 62, the stack body 14 is compressed in the stacking direction. The outer bead seal 62 is then further compressed from the height Hb2. When the height of the outer bead seal 62 reaches the height Hf of the feed ridges 52a and 52b, the feed ridges 52a and 52b exert reaction forces against the compression of the outer bead seal 62. That is, when a load larger than the fastening load is applied to the stack body 14 in the stacking direction of the stack body 14 due to an impact load or the like, the feed ridges 52a and 52b contact the MEA 28. If the impact load on the fuel cell stack 10 is not too great, compression of the outer bead seal 62 can be stopped at this stage. In this manner, according to the present embodiment, deformation of the outer bead seal 62 can be suppressed. Therefore, according to the present embodiment, the outer bead seal 62 can maintain the sealing function of the oxygen-containing gas flow field 50. As a result, according to the present embodiment, the leakage of the oxygen-containing gas from the oxygen-containing gas flow field 50 can be prevented.

Further, in the present embodiment, the existing feed ridges 52a and 52b are utilized as a structure for suppressing deformation of the outer bead seal 62. Therefore, according to the present embodiment, it is not necessary to provide new ridges or protrusions. Therefore, the first separator 30 can be simplified in terms of its fabrication process and structure.

The same applies to the passage bead seals 60 of the first separator 30, the passage bead seals 80 of the second separator 32, and the outer bead seal 82 of the second separator 32.

### 4 Invention Obtained from Embodiments

The invention that can be grasped from the above-described embodiment will be described below.

The fuel cell stack (10) according to an aspect of the present invention includes the unit cells (12) stacked in the stacking direction, the unit cells each including the membrane electrode assembly (28) and the pair of separators (30, 32) which sandwich the membrane electrode assembly, wherein each of the pair of separators includes the reactant gas flow field (50, 70) including the flow field ridge (56, 76) protruding toward the membrane electrode assembly to allow the reactant gas to flow along the electrode surface of the membrane electrode assembly, the plurality of fluid passages (34a, 34b, 38a, 38b) penetrating the separator in the thickness direction of the separator and allowing the reactant gas to flow through the fluid passages, the plurality of feed regions (48a, 48b, 68a, 68b) each including the feed ridge (52a, 52b, 72a, 72b) protruding toward the membrane electrode assembly and each configured to allow communication between the reactant gas flow field and the fluid passages, the bead seal (60, 62, 80, 82) protruding toward the membrane electrode assembly and configured to seal the space between the membrane electrode assembly and the reactant gas flow field, and between the membrane electrode assembly and the feed regions, and wherein the fastening load in the stacking direction is applied to the stack body (14) including the plurality of the unit cells, whereby the bead seals of the respective separators are compressed, the height (Hb2) of the bead seals in the stacking direction after compression is lower than the height (Hb1) of the bead seals in the stacking direction before the compression, the height (Hf) of the feed ridge in the stacking direction is lower than the height (Hb2) of the bead seals in the stacking direction after the compression.

When the outer bead seal is compressed and the height of the outer bead seal reaches the height of the feed ridges, the feed ridges exert reactions force against the compression of the outer bead seal. If the impact load on the fuel cell stack is not too great, compression of the outer bead seal can be stopped at this stage. According to the above configuration, deformation of the outer bead seal can be suppressed. Therefore, according to the above configuration, the bead seal can maintain the sealing function of the reactant gas flow field. As a result, according to the present embodiment, it is possible to prevent the gas from leaking from the reactant gas flow field. According to the present embodiment, it is not necessary to provide new ridges or protrusions. Therefore, the separator can be simplified in terms of its fabrication process and structure.

In the above aspect, the height of the feed ridge in the stacking direction may not be changed before and after the fastening load in the stacking direction is applied to the stack body.

In the above aspect, the feed ridge may not contact the membrane electrode assembly after the fastening load in the stacking direction is applied to the stack body.

In the above aspect, the feed ridge may contact the membrane electrode assembly when a load greater than the fastening load is applied to the stack body in the stacking direction.

Moreover, the present invention is not limited to the above-described disclosure, and various configurations can be adopted therein without departing from the essence and gist of the present invention.

1. A fuel cell stack comprising unit cells stacked in a stacking direction, the unit cells each including a membrane electrode assembly and a pair of separators which sandwich the membrane electrode assembly,
wherein each of the pair of separators includes:
a reactant gas flow field including a flow field ridge protruding toward the membrane electrode assembly to allow a reactant gas to flow along an electrode surface of the membrane electrode assembly;
a plurality of fluid passages penetrating the separator in a thickness direction of the separator and allowing the reactant gas to flow through the fluid passages;
a plurality of feed regions each including a feed ridge protruding toward the membrane electrode assembly and each configured to allow communication between the reactant gas flow field and the fluid passages;
a bead seal protruding toward the membrane electrode assembly and configured to seal a space between the membrane electrode assembly and the reactant gas flow field, and between the membrane electrode assembly and the feed regions, and
wherein a fastening load in the stacking direction is applied to a stack body including the plurality of the unit cells, whereby the bead seals of the respective separators are compressed,
a height of the bead seals in the stacking direction after compression is lower than a height of the bead seals in the stacking direction before the compression,
a height of the feed ridge in the stacking direction is lower than the height of the bead seals in the stacking direction after the compression.

2. The fuel cell stack according to claim 1, wherein the height of the feed ridge in the stacking direction is not changed before and after the fastening load in the stacking direction is applied to the stack body.

3. The fuel cell stack according to claim 1, wherein the feed ridge does not contact the membrane electrode assembly after the fastening load in the stacking direction is applied to the stack body.

4. The fuel cell stack according to claim 3, wherein the feed ridge contacts the membrane electrode assembly when a load greater than the fastening load is applied to the stack body in the stacking direction.
